(19) United States
(12) Patent Application Publication
(10) Pub. No.: US 2021/0243788 A1
(43) Pub. Date: Aug. 5, 2021

(54) RADIO BASE STATION AND USER TERMINAL

(71) Applicant: NTT DOCOMO, INC., Tokyo (JP)

(72) Inventors: Daisuke Murayama, Tokyo (JP); Hiroki Harada, Tokyo (JP); Kazuaki Takeda, Chiyoda-ku, Tokyo (JP); Satoshi Nagata, Tokyo (JP)

(73) Assignee: NTT DOCOMO, INC., Tokyo (JP)

(21) Appl. No.: 17/053,987

(22) PCT Filed: May 10, 2018
(86) PCT No.: PCT/JP2018/018195

§ 371 Date: Nov. 9, 2020

(51) Int. Cl. H04W 72/12; H04W 72/04; H04W 74/08

(52) U.S. Cl. CPC H04W 72/1289; H04W 72/1231; H04W 74/0816; H04W 72/0446; H04W 72/0453; H04W 72/1257

(57) ABSTRACT

A radio base station according to the present application includes a transmission section that transmits downlink control information, and a control section that controls scheduling of data, based on a relationship between an interfered apparatus and a destination apparatus. The interfered apparatus is an apparatus that is interfered with by transmission of the data scheduled in accordance with the downlink control information, and the destination apparatus is a destination of data from an interfering apparatus that interferes with a transmission apparatus of the scheduled data.

### TECHNICAL FIELD

The present invention relates to a radio base station and a user terminal in a next-generation mobile communication system.

### BACKGROUND ART

The specifications of LTE (Long Term Evolution) have been developed for the purpose of achieving higher data rates, lower latency, and so on in the UMTS (Universal Mobile Telecommunications System) network (NPL 1). Successor systems to LTE (also referred to as, for example, LTE-A (LTE-Advanced), FRA (Future Radio Access), 4G, 5G, 5G+(plus), NR (New RAT), and 3GPP (3rd Generation Partnership Project) Rel. 14, 15, 16, and beyond) are also studied for the purpose of achieving broader bands and higher speeds than those achieved by LTE.

The specifications of existing LTE systems (Rel. 8-12, for example) have been developed on the assumption of the exclusive operation in a frequency band (also referred to as a licensed band, a licensed carrier, a licensed carrier component (CC), or the like) licensed to a telecommunications carrier (operator). As the licensed CC, for example, 800 MHz, 1.7 GHz, 2 GHz, or the like is used.

In addition, the existing LTE systems (Rel. 13, for example) support the use of a frequency band (also referred to as an unlicensed band, an unlicensed carrier, or an unlicensed CC) different from the licensed band to expand the frequency band. For example, a 2.4-GHz band and a 5-GHz band in which Wi-Fi (registered trademark) and Bluetooth (registered trademark) are usable are assumed as the unlicensed bands.

Specifically, CA (Carrier Aggregation) for aggregating carriers (CC) of a licensed band and carriers (=of an unlicensed band is supported in Rel. 13. Communication performed using an unlicensed band along with a licensed band in this manner is referred to as LAA (License-Assisted Access).

The use of LAP is studied also in future radio communication systems (5G, 5G+, NR, and Rel. 15 and beyond, for example). DC (Dual Connectivity) of a licensed band and an unlicensed hand and. SA (Stand-Alone) of an unlicensed band may also be targets of the study of LAA in the future.

### CITATION LIST

### Non Patent Literature

NPL 1: 3GPP TS 36.300 V8.12.0 “Evolved Universal Terrestrial Radio Access (E-UTRA) and Evolved Universal Terrestrial Radio Access Network (E-UTRAN); Overall description; Stage 2 (Release 8)”, April 2010

### SUMMARY OF INVENTION

### Technical Problem

In future LAA systems (5G, 5G+, NR, and Rel. 15 and beyond, for example), a transmission apparatus (for example, a radio base station in the case of downlink (DL) or a user terminal in the case of uplink (UM) performs listening (also referred to as LBT: Listen Before Talk, CCA: Clear Channel Assessment, carrier sense or channel access procedure, or the like) for checking whether or not transmission is being performed by another apparatus (for example, a radio base station, a user terminal, a Wi-Fi apparatus, or the like), before transmitting data using an unlicensed band.

The transmission apparatus cancels transmission therefrom upon detecting transmission (also referred to as a busy state or an interference signal of a level that is higher than a given level (or is higher than or equal to the given level)) from the other apparatus in the listening.

However, if the transmission apparatus indiscriminately cancels transmission therefrom in response to detection f the busy state in the listening, the use efficiency of radio resources (for example, at least one of a frequency resource (for example, a band), a spatial resource, and a time resource) may decrease.

The present invention has been made in view of the above, and an object of the present invention is, to provide a radio base station and a user terminal that axe capable of preventing a decrease in use efficiency of radio resources in the case where data is transmitted in accordance with a result of listening.

### Solution to Problem

A radio base station according to an aspect of the present invention includes a transmission section that transmits downlink control information, and a control section that controls scheduling of data, based on a relationship between an interfered apparatus and a destination apparatus. The interfered apparatus is an apparatus that is interfered with by transmission of the data scheduled in accordance with the downlink control information, and the destination apparatus is a destination of data from an interfering apparatus that interferes with a transmission apparatus of the scheduled data.

A user terminal according to an aspect of the present invention includes a reception section that receives downlink control information, and a control section that controls, based on a given condition, transmission of data scheduled in accordance with the downlink control information even in a case where a busy state is detected in listening prior to transmission of the data.

### Advantageous Effects of Invention

According to the present invention, a decrease in use efficiency of radio resources can be prevented in the case where data is transmitted in accordance with a result of listening.

### BRIEF DESCRIPTION OF DRAWINGS

FIG. 1 is a diagram illustrating an example in which transmission of data from a transmission apparatus that has detected a busy state is permitted.

FIG. 2 is a diagram illustrating an example of a relationship between an interfered apparatus and a destination apparatus of data from an interfering apparatus according to an embodiment.

FIG. 3 is a diagram illustrating an example of an operation of generating an interfering/interfered table according to the embodiment.

FIG. 4 is a diagram illustrating an example of the interfering/interfered table according to the embodiment.

FIG. 5 is a diagram illustrating an example of scheduling control according to the embodiment.

FIG. 6 is a diagram illustrating an example of data transmission control according to the embodiment.

FIG. 7 is a diagram illustrating an example of a schematic configuration of a radio communication system according to the embodiment.

FIG. 8 is a diagram illustrating an example of a functional configuration of a radio base station according to the embodiment.

FIG. 9 is a diagram illustrating an example of a functional configuration or a baseband signal processing section of the radio base station according to the embodiment.

FIG. 10 is a diagram illustrating an example of a functional configuration of a user terminal according to the embodiment.

FIG. 11 is a diagram illustrating an example of a functional configuration of a baseband signal processing section of the user terminal according to the embodiment

FIG. 12 is a diagram illustrating an example of a hardware configuration of the radio base station and the user terminal according to the embodiment.

### DESCRIPTION OF EMBODIMENTS

In future LAA systems (also referred to as Rel. 15 and beyond, 5G, 5G+, NR, and the like, for example), it is studied that a transmission apparatus performs listening. (also referred to as LBT, CCA, or carrier sense or channel access procedure, or the like) for checking whether or not transmission is being performed by another apparatus before the transmission apparatus transmits data using a carrier (also referred to as a cell or a CC (Component Carrier), an unlicensed CC, an unlicensed carrier, an LAA SCell (LAA Secondary Cell), or the like) of an unlicensed band (unlicensed spectrum or NR-U (NR-Unlicensed)).

In the listening, the transmission apparatus detects a busy state or an idle state (clear state) on the basis or a reception level of an interference signal from at least one of another apparatus (for example, a radio base station (also referred to as an eNB (eNodeB), a gNB (gNodeB), a TRP (Transmission Reception Point), or the like) or a user terminal (such as a U (User Equipment)) that uses an unlicensed CC in the same system and an apparatus of another system (for example, Wi-Fi (registered trademark)) that uses the unlicensed CC.

For example, the transmission apparatus may detect the busy state when the reception level (received power) of an interference signal in the unlicensed CC in the listing is greater than a given threshold (or is greater than or equal to the given threshold). On the other hand, the transmission apparatus may detect the idle state when the reception level of the interference signal is less than or equal to the given threshold (or is less than the given threshold).

If the transmission apparatus detects the busy state in the listening, the transmission apparatus cancels (temporarily withholds) transmission of data therefrom to prevent interference with another apparatus that transmits data using the unlicensed CC. The transmission apparatus may perform listening again after a given time period. If the transmission apparatus detects the idle state, the transmission apparatus may start transmission of the data.

In addition, a collision-controlled access method (also referred to as Receiver assisted access, Receiver assisted LIST, or the like) is studied in the future LAA systems to improve the avoidance rate of data collision that occurs at a reception apparatus due to hidden terminals (hidden nodes). Collision control close to CSMA/CA (Carrier Sense Multiple Access/Collision Avoidance) with RTS/CTS (Request to Send/Clear to Send) which is introduced in the Wi-Fi system is studied for the Receiver assisted access.

Specifically, in the Receiver assisted access, a transmission apparatus that has detected the idle state in listening transmits a transmission request signal (for example, RTS) before transmitting data. If a reception apparatus is ready to receive, the reception apparatus transmits a response signal (for example, CTS) for the transmission request signal. In response to the response signal from the reception apparatus, the transmission apparatus starts transmitting data using the unlicensed CC. In this manner, the data collision probability at the reception apparatus can be reduced.

For example, schemes (1) to (3) below are studied for the Receiver assisted access.

(1) Scheme in which both the transmission request signal (for example, RTS) from the transmission apparatus and the response signal (for example, CTS) from the reception apparatus are transmitted using an unlicensed CC.
(2) Scheme in which the transmission request signal (for example, RTS) from the transmission apparatus is transmitted using an unlicensed CC and the response signal (for example, CIS) from the reception apparatus is transmitted using a licensed CC (also referred to as a carrier (cell or CC) or a PCell (Primary Cell), an SCell, or the like) of a licensed band (licensed spectrum)).
(3) Scheme in which the transmission request signal (for example, example, RTS) from the transmission apparatus is transmitted using a licensed CC and the response signal (for example, CTS) from the reception apparatus is transmitted using an unlicensed CC.

Meanwhile, the future LAA systems assume a case where transmission of data from the transmission apparatus is permitted depending on at least one of a positional relationship between apparatuses and beamforming even when. the transmission apparatus detects the busy state in listening.

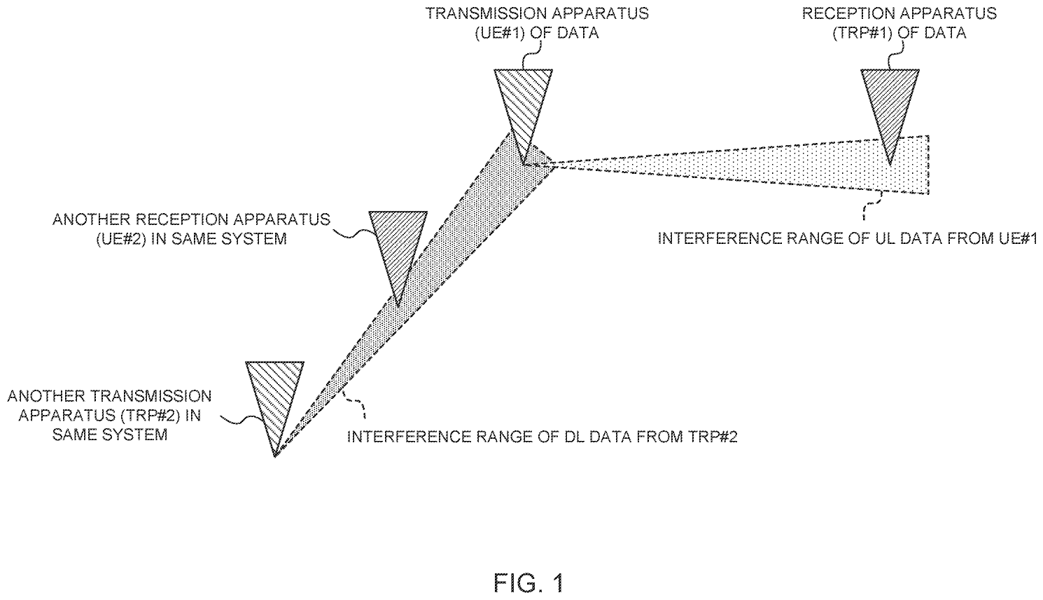

FIG. 1 is a diagram illustrating an example in which transmission of data from a transmission apparatus that has detected the busy state is permitted. FIG. 1 illustrates an example case where a UE#1 transmits UL data to a TRP#1 using an unlicensed. C. In addition, it is assumed in FIG. 1 that data directed to a UE#2 located in the same direction as the UE#1 is transmitted from a TRP#2 in the same system using the unlicensed CC.

In FIG. 1, the UE#1 performs listening before transmitting the UL data to the TRP#1. As illustrated in FIG. 1, the UE#1 is located in an interference range of the data directed to the UE#2 from the TRP#2. Therefore, the UE#1 detects the busy state on the basis of the reception level of the interference signal from the TRP#2.

On the other hand, as illustrated in FIG. 1, in the case where the TRP#1 is not located in the interference range of the data directed to the UE#2 from the TRP#2, an influence of transmission of data from the UE#1 to the TRP#1 on reception of data at the UE#2 from the TRP#2 is small even if the UE#1 detects the busy state. Therefore, concurrent transmission of the DL data from the TRP#2 to the UE#2 and the UL data from the UE#1 to the TRP#1 may be permitted in FIG. 1.

As described above, in the case where an influence of interference which transmission of data from the transmission apparatus (UE#1 in this case) imposes on the reception apparatus (UE#2 in this case) of other data in the same system is small, if the transmission apparatus indiscriminately cancels transmission of data in response to detection of the busy state, the use efficiency of radio resources (for example, at least one of a frequency resource, a spatial resource, and a time resource) may decrease (exposed terminal problem).

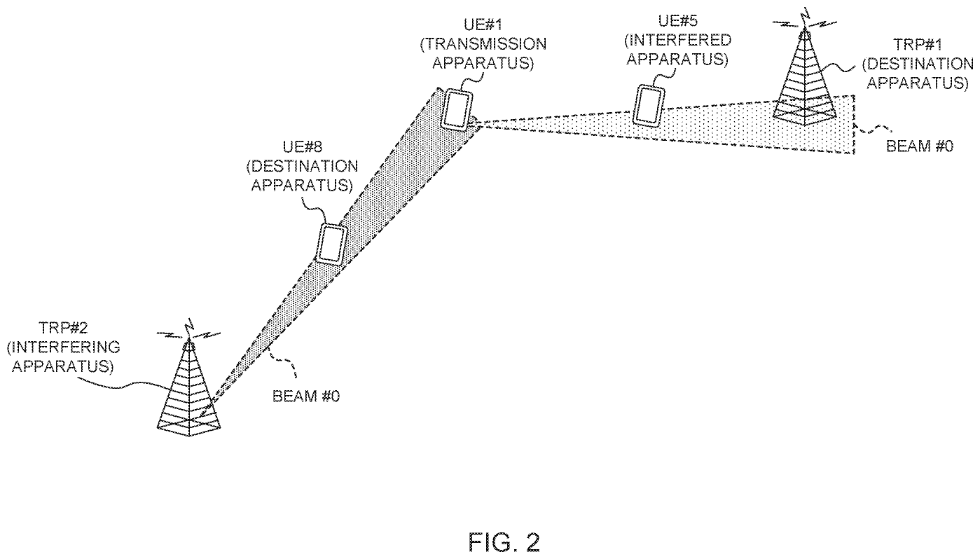

Accordingly, the inventors have conceived an idea of determining whether or not to permit transmission is data from a transmission apparatus (for example, a UE#1 in FIG. 2 described later) in the case where the busy state is detected in listening, on the basis of a relationship between an apparatus (interfered apparatus) (for example, a UE#5 in FIG. 2 described later) that is interfered with by transmission of the data and a destination apparatus (for example, a UE#8 in FIG. 2 described later) of data from an apparatus (interfering apparatus) (for example, a TRP#2 in FIG. 2 described later) that interferes with the transmission apparatus of the data.

An embodiment will be described in detail below with reference to the accompanying drawings. In the present embodiment, a transmission apparatus of data may use an access scheme (existing LBT) in which collision control is not performed or may use the above-described. Receiver assisted access.

In addition, in the present embodiment, the transmission apparatus of data may be, for example, a radio base station (also referred to as an eNB, a gNB, a TRP, or the like) in the downlink (DL). In addition, the transmission apparatus may be a user terminal (UE) in the uplink (UL). Further, a reception apparatus that receives data from the transmission apparatus may be, for example, a user terminal in the DL and a radio base station in the UL, Scheduling and transmission control described below are applicable to at least one of UL data and DL data. In addition, the present embodiment may be applied not only to UL data and DL data but also to other UL signals and DL signals.

In the present embodiment, a TRP may control scheduling of data on the basis of a relationship between an interfered apparatus that is interfered with by transmission of data scheduled in accordance with DCI (Downlink Control information) and a destination apparatus of data from an interfering apparatus that interferes with the transmission apparatus of the data.

The data scheduled in accordance with the DCI may include at least one of UL data and DL data. UL data may be referred to as a PUSCH (Physical Uplink Shared Channel) or the like. DL data may be referred to as a PDSCH (Physical Downlink Shared Channel) or the like.

FIG. 2 is a diagram illustrating an example of a relationship between an interfered apparatus and a destination apparatus of data from an interfering apparatus according to the present embodiment. For example, in FIG. 2, when data is transmitted using a beam 40 from the UE#1, the interfered apparatuses interfered with by the transmission of the data from the UE#1 are the UE#5 and a TRP#1. In addition, when data is transmitted using the beam #0 from the TRP#2, interfered apparatuses interfered with by the transmission of the data from the TRP#2 are the UE#8 and the UE#1.

In FIG. 2, the UE#1 detects the busy state due to the data from the TRP#2 in listening performed prior to transmission of the data using the beam #0. On the other hand, the interfered apparatuses (the UE#5 and the TRP#1) interfered with by the transmission of the data using the beam 40 from the UE#1 do not include the destination apparatus (the UE#8) of the data from the interfering apparatus (the TRP#2) for the UE#1.

As described above, if the interfered apparatuses (for example, the UE#5 and the TRP#1) interfered with by the UE#1 do not include the destination apparatus (for example, the UE#8) of the data from the interfering apparatus (for example, the TRP#2) for the UE#1, the data from the UE#1 may be scheduled to a resource that is identical to a resource of the data from the interfering apparatus to the destination apparatus in terms of at least one of a time domain and a frequency domain. Therefore, the TRP#1 may control scheduling of the data from the UE#1 on the basis of a relationship between the interfered apparatus (for example, the UE#5) interfered with by the data from the UE#1 to the TRP#1 and the destination apparatus (for example, the UE#8) of the data from the interfering apparatus (for example, the TRP#2) for the UE#1.

### (Operation of Generating Interfering/Interfered Table)

A TRP may receive information indicating a result or listening from at least one of a UE or a TRP (adjacent TRP) that is adjacent thereto, and generate a table (interfering/interfered table) in which a transmission apparatus of data and an interfered apparatus are associated with each other on the basis of the information. The TRP may determine a relationship between an interfered apparatus from the transmission apparatus of the data and a destination apparatus of data from the interfering apparatus for the transmission apparatus by using the interfering/interfered table.

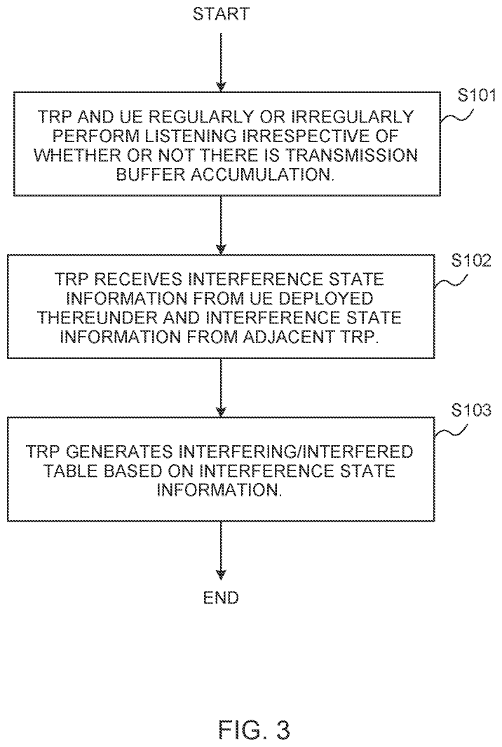

FIG. 3 is a diagram illustrating an example of the operation of generating the interfering/interfered table according to the present embodiment. As illustrated in FIG. 3, in step S101, each TSP and each UE perform listening regularly or irregularly irrespective of whether or not data is accumulated in a transmission buffer (transmission buffer accumulation).

The listening may be performed, for example, at a given time, on a given cycle, or irregularly on the basis of trigger information from a TRP. The TRP may report, to each UE, information indicating at least one of the time and the cycle at which the listening is to be performed using, for example, higher-layer signaling (for example, RRC (Radio Resource Control) signaling) on a licensed CC. In addition, the TRP may report, to each UE, the trigger information using, for example, L1 signaling (for example, DCI ((Downlink Control Information) or a downlink control channel (PDCCH: Physical Downlink Control Channel)) on a licensed CC.

Each UE reports, to the TRP, information regarding the interference state on the basis of the result of the listening performed in step S101. The information regarding the interference state may include, for example, at least one of information (interference state information) indicating the interference state (either the busy state or the idle state) for each listening performed in step S101 and information (timestamp) indicating the time at which the listening was performed.

For example, each UE may report, to the TRP, the interference state information using at least one of higher-layer signaling (for example, RRC signaling) and L1 signaling (for example, UCI (Uplink Control. Information), an uplink control channel (PUCCH: Physical Uplink Control Channel), and an uplink shared channel (PUSCH: Physical Uplink Shared Channel)) on a licensed CC. Each UE may also report, to the TRP, the interference state information using an unlicensed CC.

Each TRP reports, to the adjacent TRP, information regarding the interference state on the basis of the result of the listening performed in step S101. The adjacent TRP is also referred to as an adjacent cell, an adjacent base station, a neighbor TRP, a neighbor cell, a neighbor base station, or the like. For example, each TRP may report, to the adjacent TRP, the interference state information using a wired interface (for example, X2 interface) or a wireless connection (for example, a licensed CC or an unlicensed CC).

In step S102, each TRP receives at least one of the interference state information from each UE deployed thereunder and the interference state information from the adjacent TRP.

In step S103, each TRP may generate the interfering/interfered table in which at least a transmission apparatus (transmission entity) (also referred to as an interfering apparatus (interfering entity) or the like) of data and an apparatus (also referred to as an interfered apparatus (interfered entity) or the like) that is interfered with by transmission of the data from the transmission apparatus are associated with each other on the basis of these pieces of interference state information.

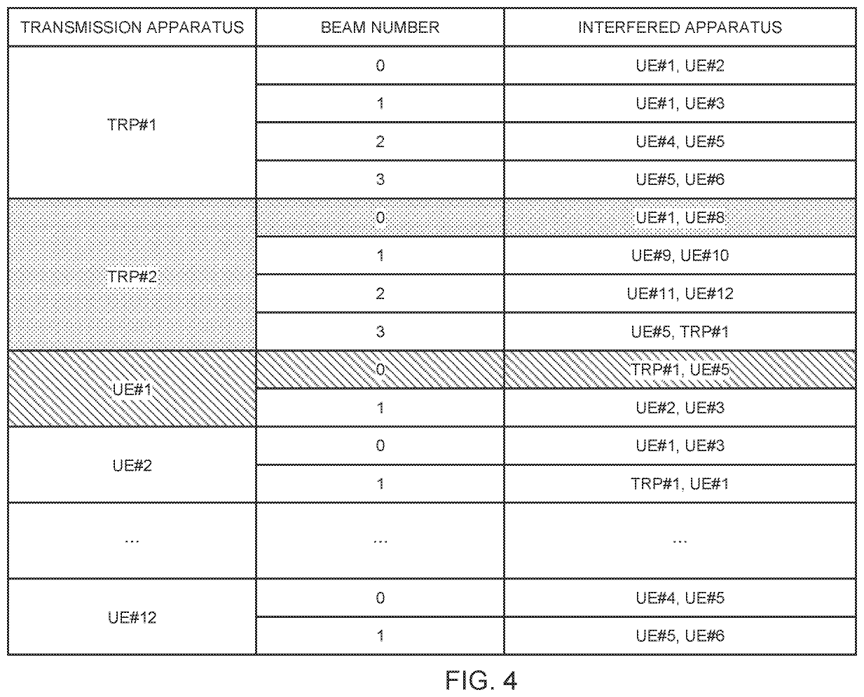

FIG. 4 is a diagram illustrating an example of the interfering/interfered table according to the present embodiment. As illustrated in FIG. 4, an identifier (index, number, or transmission apparatus ID) of a transmission apparatus, an identifier (index, number, or interfered apparatus ID) of an interfered apparatus, and an identifier (index, number, or beam number) of a beam may be associated with one another in the interfering/interfered table.

Note that association of the beam number may be omitted. In addition, the beam number may be replaced with information that enables identification of a beam or information from which a QCL (Quasi-Co-Location) relationship with a beam used for transmitting data is assumed. For example, the beam number may be replaced with at least one of pieces of information below.
State (TCI state) of a TCI (Transmission Configuration Indicator)
Time position (index or SSB index) of an. SSB (Synchronization Signal Block)
Identifier (CRI: CSI-RS resource indicator) of a resource of a CSI-RS (Channel State Information-Reference Signal)
Number (identifier) of a port (DMRS port) of a DMRS (DeModulation Reference Signal)

The interfering/interfered table illustrated in FIG. 4 presents the TRP#1 and the UE#5 which are interfered apparatuses interfered with by data transmission performed. by the UE#1 using the beam #0 as described in FIG. 2. The interfering/interfered table illustrated in FIG. 4 also presents the interfered apparatuses UE#1 and the UE#8 interfered with by data transmission performed by the TRP#2 using the beam 40. This indicates that the interfering apparatus for the UE#1 is the TRP#2.

With such an interfering/interfered table, relationship between an interfered apparatus interfered with by a transmission apparatus of data and a destination apparatus of data from an interfering apparatus for the transmission apparatus can be easily grasped.

### (Scheduling Control)

Scheduling control using the interfering/interfered table will be described next.

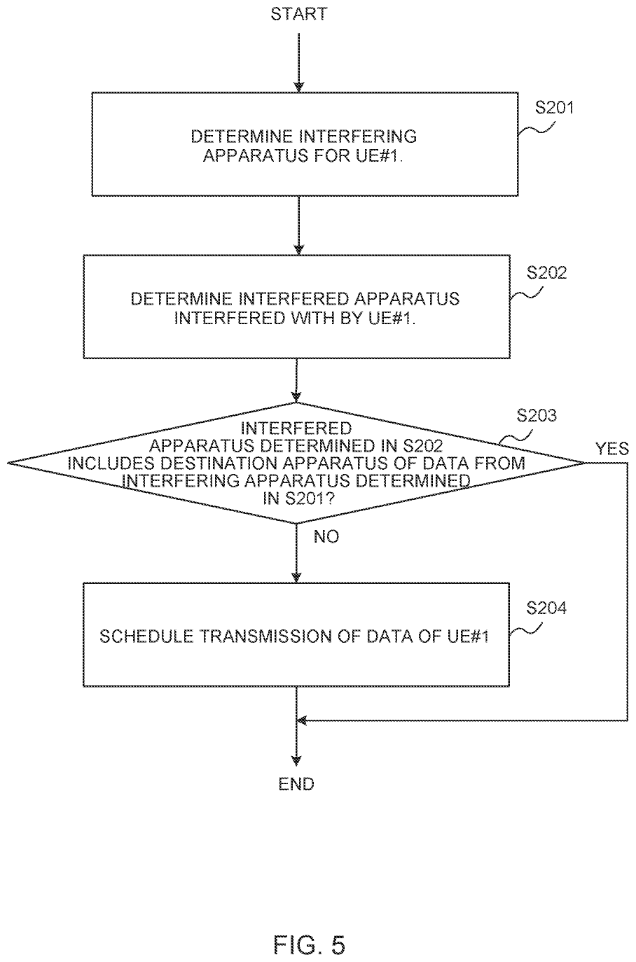

FIG. 5 is a diagram illustrating an example of scheduling control according to the present embodiment. For example, it is assumed in FIG. 5 that a network (for example, the TRP#1) creates and stores the interfering/interfered table illustrated in FIG. 4 and controls scheduling of UL data from the UE#1 on the basis of the interfering/interfered table.

In step S201 in FIG. 5, the TRP#1 determines an interfering apparatus for the UE#1 when scheduling transmission of UL data from the UE#1 to the TRP#1 using the beam 40 in an unlicensed CC. Specifically, the TRP#1 may determine the interfering apparatus for the UE#1 on the basis of at least one of scheduling information at the TRP#1, scheduling information at the adjacent TRP, and the interfering/interfered table illustrated in FIG. 4.

For example, it is assumed that, in the case illustrated in FIG. 2, the TRP#1 grasps, on the basis of the scheduling information at the adjacent TRP 42, that a frequency resource of an unlicensed CC to be scheduled for the UL data from the UE#1 is allocated for transmission of DL data from the TRP#2 to the UE#8 using the beam 40. In this case, the TRP#1 may determine the TRP#2 as the interfering apparatus for the UE#1 on the basis of the interfering/interfered table illustrated in FIG. 4.

In addition, in step S202 in FIG. 5, the TRP#1 determines an interfered apparatus interfered with by transmission of the UL data from the UE#1 to the TRP#1 using the beam 40. Specifically, the TRP#1 may determine the interfered apparatus interfered with by the UE#1 on the basis of the interfering/interfered table illustrated in FIG. 4. For example, in the case illustrated in FIG. 2, the TRP#1 may determine the UE#5 as the interfered apparatus interfered with by transmission of the UL data from the UE#1 to the TRP#1 using the beam #0 on the basis of the interfering/interfered table illustrated in. FIG. 4

In step S203 in FIG. 5, the TRP#1 determines whether or not the interfered apparatus (for example, the UE#5 in FIG. 2) determined in step S202 includes a destination apparatus (for example, the UE#8 in FIG. 2) of data from the interfering apparatus determined in step S201.

If the interfered apparatus determined in step S202 does not include the destination apparatus of the data from the interfering apparatus determined in step S201 (step S203; NO), the TRP#1 schedules transmission of the UL data from the UE#1 to the TRP#1 using the beam #0 in step S204. For example, in the case illustrated in FIG. 2, the interfered apparatus (the UE#5) determined in step S202 does not include the destination apparatus (the UE#8) of the data from the interfering apparatus (the TRP#2) determined in step S201. Thus, the TRP#1 schedules transmission of the UL data from the UE#1.

Note that the TRP#1 may transmit, to the UE#1, the DCI for scheduling transmission of the UL data from the UE#1. The DCI may include information indicating that transmission. is permitted even if a result of listening performed by the UE#1 indicates the busy state. In addition, the DCI may include information indicating at least one of the interfering apparatus for the UE#1 and the destination apparatus of data from the interfering apparatus.

On the other hand, if the interfered apparatus determined in step S202 includes be destination apparatus of the data from the interfering apparatus determined in step S201 (step S203; YES), the TRP#1 may cancel scheduling of transmission of the UL data from the UE#1 to the IRP#1 using the beam #0.

Although scheduling control of the UL data from the UE#1 performed by the TRP#1 has been described in FIG. 5, the flowchart illustrated in FIG. 5 is also applicable to scheduling control of DL data from the TRP#1. When the flowchart illustrated in FIG. 5 is applied to scheduling control of the DL data from the TRP#1, “the UL data from the UE#1” may be replaced with “the DL data from the TRP#1”. In addition, the TRP#1 may start transmitting the DL data after scheduling is performed in step S204.

The steps illustrated in FIG. 5 need not be performed in time series, and the order of the steps may be changed, one or some of the steps may be omitted, or a step not illustrated may be added.

### (Data Transmission Control)

Control on transmission of data scheduled in the above-described manner will be described next.

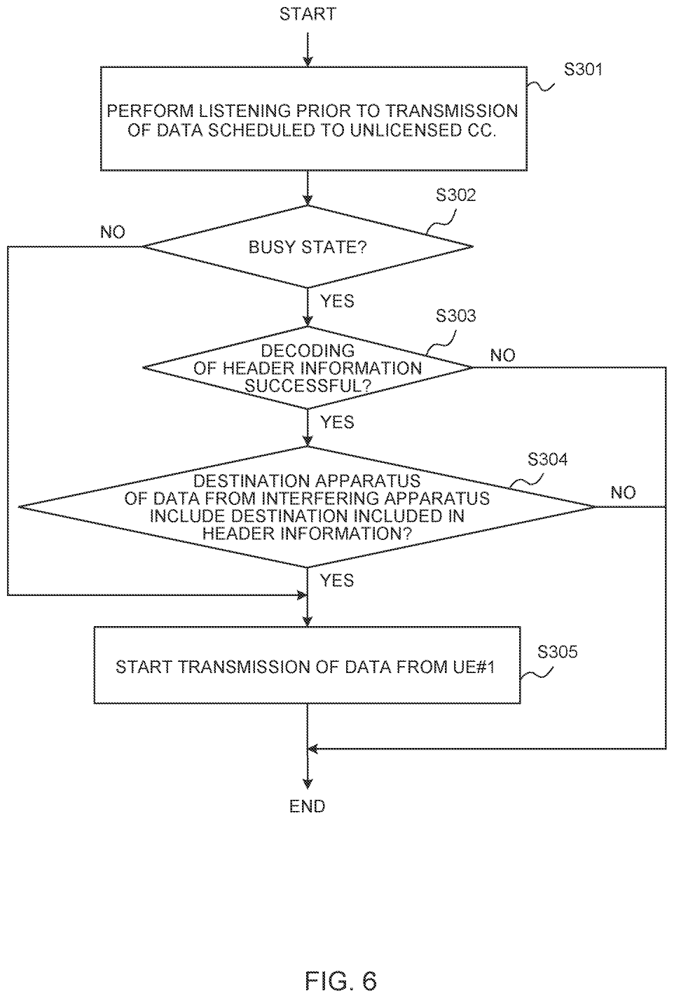

FIG. 6 is a diagram illustrating an example of data transmission control according to the present embodiment. In FIG. 6, the interfering/interfered table generated by the network (for example, the TRP#1) may be reported to or may not reported to the UE#1.

In step S301 in FIG. 6, the UE#1 performs listening prior to transmission of UL data scheduled to an unlicensed CC (for example, the UL data transmitted to the TRP#1 using the beam #0 in FIG. 2).

In step S302, the UE#1 detects whether or not the channel is in the busy state on the basis of a result of the listening. If the UE#1 does not detect the busy state (detects the idle state) (step S302; NO), the UE#1 starts transmission of the scheduled UL data.

On the other hand, if the UE#1 detects the busy state (step S302 YES), the UE#1 decodes header information of a signal (interference signal) detected in the listening in step S303.

If the decoding of the header information of the interference signal is unsuccessful (step S303; NO), the UE#1 cancels transmission of the scheduled UL data. This is because unsuccessful decoding of the header information of the interference signal indicates a possibility of an apparatus (for example, a Wi-Fi apparatus) of another system performing transmission using the unlicensed CC.

If the decoding of the header information of the interference signal is successful (step S303; YES), the UE#1 at least determines whether or not the destination apparatus of the data from the interfering apparatus for the UE#1 includes the destination included in the decoded header information in step S304. The UE#1 may also determine whether or not the interfering apparatus for the UE#1 and the destination apparatus of the data from the interfering apparatus include a destination and a transmission source included in the decoded header information.

For example, in FIG. 2, the interfering apparatus for the UE#1 is the TRP#2, and the destination apparatus of the data from the interfering apparatus is the UE#8. The UE#1 may determine whether or not the transmission source and the destination included in the header information decoded in step S303 include the TRP#2 and the UE#8 or include only the UE#8.

Note that the UE#1 may identify the interfering apparatus (for example, the TRP#2 in FIG. 2) for the UE#1 and the destination apparatus (for example, the UE#8 in FIG. 2) of the data from the interfering apparatus with reference to the interfering/interfered table or on the basis of the DCI.

If the interfering apparatus for the UE#1 and the destination apparatus of the data from the interfering apparatus include the transmission source and the destination included in the decoded header information (S304; YES), the UE#1 starts transmission of the scheduled UL data in step S305.

On the other hand, if the interfering apparatus for the UE#1 and the destination apparatus of the data from the interfering apparatus do not include the transmission source and the destination included in the decoded header information (step S304; NO), the UE#1 cancels transmission of the scheduled UL data.

As described above, even when the busy state is detected in listening, transmission of data is permitted on the basis of a relationship between an interfered apparatus (for example, the UE#5 in FIG. 2) interfered with by transmission of the data and a destination apparatus (for example, the UE#8 in FIG. 2) of data from an interfering apparatus (for example, the UE#8 in FIG. 2) for a transmission apparatus (for example, the UE#1 in FIG. 2) of the data. This thus can improve the use efficiency of radio resources.

### (Radio Communication System)

A configuration of a radio communication system according to the present embodiment will be described below. The radio communication method according to each aspect described above is applied to this radio communication system. Note that the radio communication methods according to the respective aspects described above may be applied individually or in combination.

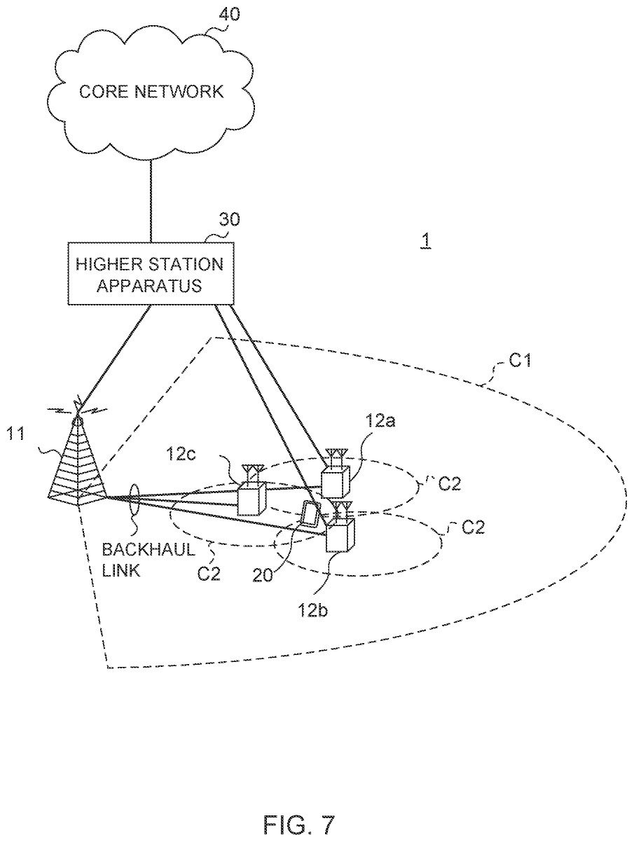

FIG. 7 is a diagram illustrating an example of a schematic configuration of the radio communication system according to the present embodiment. Carrier aggregation (CA) and/or dual connectivity (DC) for aggregating a plurality of fundamental frequency blocks (component carriers) which are in units of a system bandwidth (for example, 20 MHz) of the LTE system can be applied to a radio communication system 1. Note that the radio communication system 1 may also be referred to as Super 3G, LTE-A (LTE-Advanced), IMT-Advanced, 4G, 5G, FRA (Future Radio Access), NR (New Rat), or the like.

The radio communication system 1 illustrated in FIG. 7 includes a radio base station 11 that forms a macro cell C1, and radio base stations 12ato 12c each of which is located in the micro cell C1 and forms a small cell C2 that is narrower than the macro cell C1. In addition, a user terminal 20 is located in the macro cell C1 and each small cell C2. A configuration may be adopted in which different numerologies are applied to different cells. Note that the term “numerology” refers to a communication parameter set that characterizes the design of signals in a certain RAT or the design of the RAT.

The user terminal 20 is capable of connecting to both of the radio base station 11 and the radio base stations 12. The user terminal 20 is assumed to concurrently use, thanks to the CA or the DC, the macro cell C1 and the small cells C2 which use different frequencies. In addition, the user terminal 20 is capable of applying the CA or the DC using a plurality of cells (CC) (for example, two or more CCs). Further, the user terminal is capable of using a licensed band CC and an unlicensed band CC as the plurality of cells. Note that a configuration may be adopted in which any of the plurality of cells includes a TDD carrier to which a short TTI is applied.

Communication can be performed between the user terminal 20 and the radio base station 11 using a carrier (referred to as an existing carrier, Legacy carrier, or the like) having a narrow bandwidth in a relatively low frequency band (for example, 2 GHz). On the other hand, a carrier having a wide bandwidth in a relatively high frequency band (for example, 3.5 GHz, 5 GHz, 30 to 70 GHz, or the like) may be used or the same carrier for the radio base station 11 may be used between the user terminal 20 and the radio base stations 12. Note that the configuration of the frequency band used by each radio base station is not limited to this.

A configuration may be adopted in which a wired connection (for example, an optical fiber conforming to CPRI (Common Public Radio Interface), an X2 interface, or the like) or a wireless connection may be used between the radio base station 11 and each radio base station 12 (or between the two radio base stations 12).

The radio base station 11 and each of the radio base stations 12 are connected to a higher station apparatus 30 and are connected to a core network 40 via the higher station apparatus 30. Note that examples of the higher station apparatus 30 include, but not limited to, an access gateway apparatus, a radio network controller (RNC), a mobility management entity (MME), and the like. In addition, each of the radio base stations 12 may be connected to the higher station apparatus 30 via the radio base station 11.

Note that the radio base station 11 is a radio base station having a relatively broad coverage and may be referred to as a macro base station, a central node, an eNB (eNodeB), a TRP, or the like. In addition, the radio base station 12 is a radio base station having a local coverage and may be referred to as a small base station, a micro base station, a pica base station, a femto base station, a HeNB (Home eNodeB), an RRH (Remote Radio Head), a TRP, or the like. Hereinafter, the radio base stations 11 and 12 are collectively referred to as radio base stations 10 when they are not distinguished from each other.

Each user terminal 20 is a terminal that supports various communication schemes such as LTE, LTE-A, NR, 5G, and 5G+ and may be not only a mobile communication terminal but also a fixed communication terminal.

In the radio communication system 1, OFDMA (Orthogonal Frequency Division Multiple Access) and SC-FDMA (Single-Carrier Frequency Division Multiple Access) may be respectively applied to the downlink (DL) and the uplink (UL) as the radio access schemes. OFDMA is a multi-carrier transmission scheme in which a frequency band is divided into a plurality of narrow frequency bands (sub-carriers) and data is mapped to each sub-carrier to perform communication. SC-FDMA is a single-carrier transmission scheme in which a system bandwidth is divided into bands consisting of a single resource block or contiguous resource blocks for each terminal and a plurality of terminals use different bands from each other to reduce interference between the terminals. Note that the uplink and downlink radio access schemes are not limited to the combination of these, and. OFDMA may be used in the UL.

The radio communication system 1 uses, as DL channels, a downlink data channel (also referred to as a PDSCH: Physical Downlink Shared Channel a downlink shared channel, or the like) shared among the individual user terminals 20, a broadcast channel (PBCH: Physical Broadcast Channel), an L1/L2 control channel, and so on. User data, higher-layer control information, an SIB (System Information Block), and so on are transmitted on the PDSCH. In addition, an MIB (Master Information Block) is transmitted on the PBCH.

The L1/L2 control channel includes downlink control channels (a PDCCH (Physical Downlink Control Channel) and an EPDCCH (Enhanced. Physical Downlink Control Channel)), a PCFICH (Physical Control Format Indicator Channel), a PHICH (Physical Hybrid-ARQ Indicator Channel), and so on. The DCI (Downlink Control. Information) including the scheduling information of the PDSCH and the PUSCH or the like is transmitted on the PDCCH. The number of OFDM symbols used in the PDCCH is transmitted on the PCFICH. Delivery confirmation information (ACK/NACK) of HARQ for the PUSCH is transmitted on the PHICH. The EPDCCH is subjected to frequency-division multiplexing with the PDSCH (downlink shared channel) and is used for transmission of the DCI or the like similarly to the PDCCH.

The radio communication system 1 uses, as UL channels, an uplink data channel (also referred to as a PUSCH: Physical Uplink Shared Channel, an uplink shared channel, or the like) shared among the individual user terminals 20, an uplink control channel (PUCCH: Physical Uplink Control Channel), a random access channel (PRACH: Physical Random Access Channel), and so on. User data and higher-layer control information are transmitted on the PUSCH. UCI (Uplink Control Information) including at least one of delivery confirmation information (ACK/NACK), radio quality information (CQI), and so on is transmitted on the PUSCH or the PUCCH. A random access, preamble for establishing a connection to a cell is transmitted on the PRACH.

### <Radio Base Station>

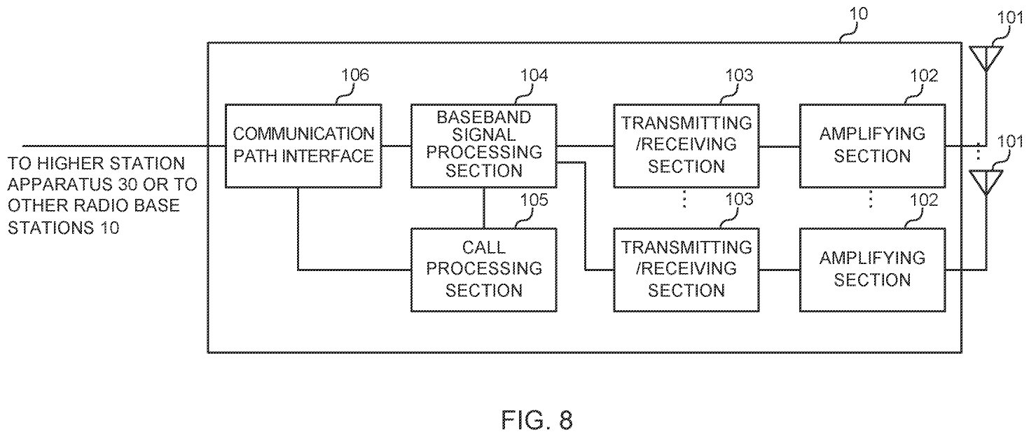

FIG. 8 is a diagram illustrating an example of an overall configuration of a radio base station according to the present embodiment. The radio base station 10 includes a plurality of transmit/receive antennas 101, amplifying sections 102, transmitting/receiving sections 103, a baseband signal processing section 104, a call processing section 105, and a communication path interface 106. Note that a configuration may be made so that the radio base station 10 includes one or more transmit/receive antennas 101, one or more amplifying sections 102, and one or more transmitting/receiving sections 103. The radio base station 10 may be a transmission apparatus in the downlink and a reception apparatus in the uplink.

Downlink data to be transmitted from the radio base station 10 to the user terminal 20 is input to the baseband signal processing section 104 via the communication path interface 106 from the higher station apparatus 30.

The baseband signal processing section 104 performs, on the downlink data, processing of the PDCP (Packet Data Convergence Protocol) layer, division/combination of user data, RLC layer transmission processing such as RLC (Radio Link Control) retransmission control, MAC (Medium Access Control) retransmission control (for example, HARQ transmission processing), and transmission processing such as scheduling, transmission format selection, channel encoding, IFFT (Inverse Fast Fourier Transform.) processing, and precoding processing, and transfers the resultant downlink data to the transmitting/receiving sections 103. In addition, the baseband signal processing section 104 performs transmission processing such as channel encoding and IFFT on a downlink control signal and transfers the resultant downlink control signal to the transmitting/receiving sections 103.

Each of the transmitting/receiving sections 103 converts the baseband signal that has been precoded and output for the corresponding antenna from the baseband signal processing section 104 to have a radio frequency band and transmits the resultant signal. The radio frequency signal obtained through the frequency conversion by the transmitting/receiving section 103 is amplified by the amplifying section 102, and the amplified radio frequency signal is transmitted from the transmit/receive antenna 101. The transmitting/receiving section 103 may be constituted by a transmitter/receiver, a transmission/reception circuit, or a transmission/reception apparatus described based on a common recognition in Technical Field of the present invention. Note that the transmitting/receiving section 103 may be constituted by an integrated transceiver section or by a transmission section and a reception section.

On the other hand, as for an uplink signal, a radio frequency signal received by the transmit/receive antenna 101 is amplified by the amplifying section 102. The transmitting/receiving section 103 receives the uplink signal amplified by the amplifying section 102. The transmitting/receiving section 103 performs frequency conversion on the received signal to obtain a baseband signal and outputs the baseband signal to the baseband signal processing section 104.

The baseband signal processing section. 104 performs, on user data included in the uplink signal input thereto, reception processing such as FFT (Fast Fourier Transform) processing, IDFT (Inverse Discrete Fourier Transform) processing, error correction decoding, and MAC retransmission control, and reception processing of the RLC layer and the PDCP layer, and transfers the resultant user data to the higher station apparatus 30 via the communication path interface 106. The call processing section 105 performs processing of a call for setting or releasing a communication channel, management of the state of the radio base station 10, and management of radio resources.

The communication path interface 106 transmits and receives a signal to and from the higher station apparatus 30 via a given interface. In addition, the communication path interface 106 may transmit and receive a signal to and from. (perform backhaul signaling with) another radio base station 10 via an interface (for example, an optical fiber conforming to CPRI (Common Public Radio Interface) or an X2 interface) between the base stations.

Note that the transmitting/receiving section 103 transmits downlink signals (for example, a downlink control signal (downlink control channel), a downlink data signal (downlink data channel, downlink shared channel), a downlink reference signal (such as the DM-RS or the CST-RS), a discovery signal, a synchronization signal, a broadcast signal, and so on), and receives uplink signals (for example, an uplink control signal (uplink control channel), an uplink data signal (uplink data channel, uplink shared channel), an uplink reference signal, and so on).

Specifically, the transmitting/receiving section 103 may transmit data using an unlicensed CC (first frequency band). In addition, the transmitting/receiving section 103 may receive data using an unlicensed CC (first frequency band). The transmitting/receiving section 103 may transmit the DCI.

In addition, the transmitting/receiving section 103 may receive information indicating the result of listening from the user terminal 20. In addition, the communication path interface 106 may receive information indicating the result of listening from the adjacent radio base station 20.

A transmission section and a reception section according to the present invention are constituted by the transmitting/receiving section 103 and/or the communication path interface 106.

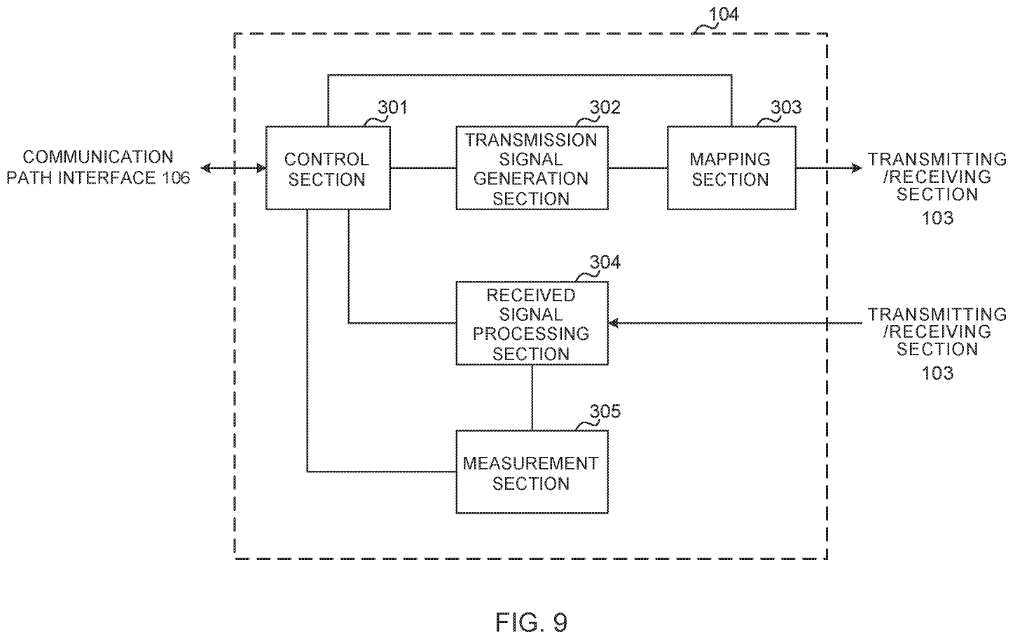

FIG. 9 is a diagram illustrating an example of a functional configuration of the radio base station according to the present embodiment. Note that it is assumed that FIG. 9 mainly illustrates functional blocks that are feature portions of the present embodiment and the radio base station 10 includes other functional blocks necessary for radio communication. As illustrated in FIG. 9, the baseband signal processing section 104 at least includes a control section 301, a transmission signal generating section 302, a mapping section 303, a reception signal processing section 304, and a measuring section 305.

The control section 301 performs control of the entire radio base station 10. The control section 301 may be constituted by a controller, a control circuit, or a control apparatus described based on a common recognition in Technical Field of the present invention.

The control section 301 controls, for example, generation of a signal performed by the transmission signal generating section 302 and allocation of the signal performed by the mapping section 303. The control section 301 also controls signal reception processing performed by the reception signal processing section. 304 and signal measurement performed by the measuring section 305.

The control section 301 controls scheduling of a downlink signal and/or an uplink signal (for example, resource allocation). Specifically, the control section 301 controls the transmission signal generating section 302, the mapping section 303, and the transmitting/receiving section 103 so that the DCI (DL assignment, DL grant) including scheduling information of a downlink data channel or the DCI (UL grant) including scheduling information of an uplink data channel are generated and transmitted.

The control section 301 controls scheduling of data. Specifically, the control section 301 may control scheduling of the data on the basis of a relationship between an apparatus that is interfered with by transmission of data scheduled in accordance with the DCI and a destination apparatus of data from an apparatus that interferes with the transmission apparatus of the data.

In addition, the control section 301 may control generation of a table (for example, FIG. 4) in which the transmission apparatus and the interfered apparatus are associated with each other, on the basis of information indicating a result of listening received from at least one of the user terminal 20 and the adjacent radio base station 10.

Further, the control section 301 may determine, using the table, a relationship between an apparatus that is interfered with by transmission of data from a transmission apparatus and a destination apparatus of data from an apparatus that interferes with the transmission apparatus.

Specifically, if the interfered apparatus does not include the destination apparatus, the control section 301 may schedule the data from the transmission apparatus to a resource that is identical to a resource of the data to the destination apparatus from the interfering apparatus in terms of at least one of a time domain and a frequency domain.

In addition, the control section 301 may transmit the data even if the busy state is detected in listening performed prior to transmission of the data scheduled in accordance with the DCI. In addition, the control section 301 may control transmission of the data on the basis of a signal detected in the listening when the busy state is detected in the listening.

Further, the control section 301 may control listening in an unlicensed CC.

The transmission signal generating section 302 generates a downlink signal (such as a downlink control channel, a downlink data channel, or a downlink reference signal such as the DM-RS) on the basis of an instruction from the control section 301, and outputs the downlink signal to the mapping section 303. The transmission signal generating section 302 may be constituted by a signal generator, a signal generation circuit, or a signal generation apparatus described based on a common recognition in Technical Field of the present invention.

The mapping section 303 maps the downlink signal generated by the transmission signal generating section 302 to a given radio resource on the basis of an instruction from the control section 301 and outputs the resultant downlink signal to the transmitting/receiving section 103. The mapping section 303 may be constituted by a mapper, a mapping circuit, or a mapping apparatus described based on a common recognition in Technical Field of the present invention.

The reception signal processing section 304 performs reception processing (for example, demapping, demodulation, decoding, and so on) on a reception signal input thereto from the transmitting/receiving section 103. Here, the reception signal is, for example, an uplink signal (such as an uplink control channel, an uplink data channel, or an uplink reference signal) transmitted from the user terminal 20. The reception signal processing section 304 may be constituted by a signal processor, a signal processing circuit, or a signal processing apparatus described based on a common recognition in Technical Field of the present invention.

The reception signal processing section 304 outputs information decoded through the reception processing to the control section 301. For example, the reception processing unit 304 outputs at least one of the preamble, the control information, and the uplink data to the control section 301. The reception signal processing section 304 also outputs the reception signal, and a signal resulting, from the reception processing to the measuring section 305.

The measuring sect on 305 performs measurement on the received signal. The measuring section 305 may be constituted by a measurer, a measuring, circuit, or a measuring apparatus described based on a common recognition in Technical Field of the present invention.

The measuring section 305 may measure the received. power (for example, RSRP (Reference Signal Received Power)) or the received quality (for example, RSRQ (Reference Signal Received. Quality)), a channel state, or the like of the received signal. A result of the measurement may be output to the control section 301.

### <User Terminal>

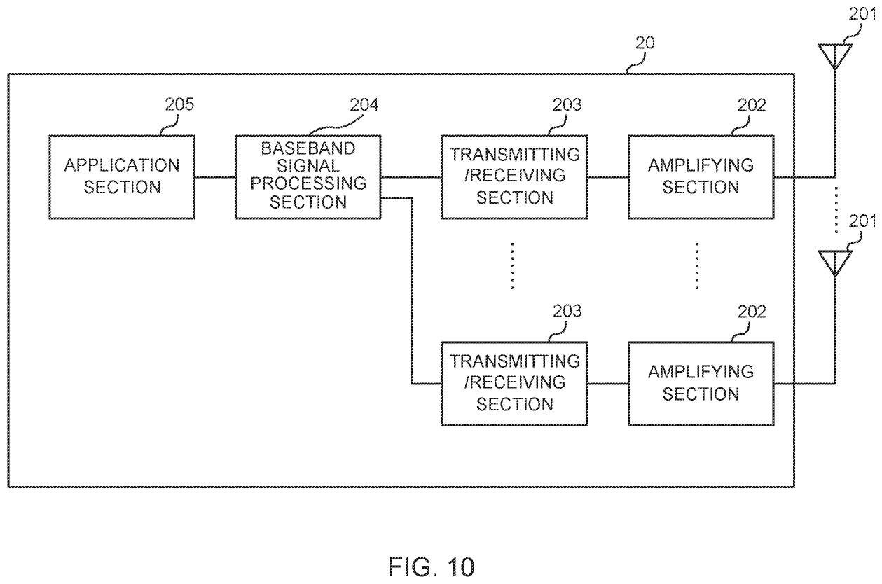

FIG. 10 is a diagram illustrating an. example of an overall configuration of the user terminal according to the present embodiment. The user terminal 20 includes a plurality of transmit/receive antennas 201, amplifying sections 202, transmitting/receiving sections 203, a baseband signal processing section 204, and an application section 205. Note that a configuration may be made so that the user terminal 20 includes one or more transmit/receive antennas 201, one or more amplifying, sections 202, and one or more transmitting/receiving sections 203. The user terminal 20 may be a reception apparatus in the downlink and a transmission apparatus in the uplink.

A radio frequency signal received by the transmit/receive antenna 201 is amplified by the amplifying section 202. The transmitting/receiving section 203 receives the downlink signal amplified by the amplifying section 202. The transmitting/receiving section 203 performs frequency conversion on the reception signal to obtain a baseband signal and outputs the baseband signal to the baseband signal processing section 204. The transmitting/receiving section 203 may be constituted by a transmitter/receiver, a transmission/reception circuit, or a transmission/reception apparatus described based on a common recognition in Technical Field of the present invention. Note that the transmitting/receiving section 203 may be constituted by an integrated transceiver section or by a transmission section and a reception section.

The baseband signal processing section 204 performs reception processing such as FFT processing, error correction decoding, and retransmission control or the like on the input baseband signal. The downlink data is transferred to the application section 205. The application section 205 performs processing regarding the higher layer than the physical layer and the MAC layer. In addition, system information and higher-layer control information are also transferred to the application section 205 among the downlink data.

On the other hand, uplink data is input to the baseband signal processing section 204 from the application section 205. The baseband signal processing section 204 performs transmission processing of retransmission control (for example, HARQ transmission processing), channel encoding, preceding, DFT (Discrete Fourier Transform) processing, IFFT processing, and so on, and transfers the resultant signal to the transmitting/receiving section 203. The transmitting/receiving section 203 converts the baseband signal output from the baseband signal processing section 204 to have a radio frequency band and transmits the resultant signal. The radio frequency signal obtained through the frequency conversion by the transmitting/receiving section 203 is amplified by the amplifying section 202, and the amplified radio frequency signal is transmitted from the transmit/receive antenna 201.

Note that the transmitting/receiving section 203 receives downlink signals (for example, a downlink control signal (downlink control channel), a downlink data signal (downlink data channel, downlink shared channel), a downlink reference signal (such as the DM-RS or the CSI-RS), a discovery signal, a synchronization signal, a broadcast signal, and so on), and transmits uplink signals (for example, an uplink control signal (uplink control channel), an uplink data signal (uplink data channel, uplink shared channel), an uplink reference signal, and so on).

Specifically, the transmitting/receiving section 203 may transmit data using an unlicensed CC (first frequency band). In addition, the transmitting/receiving section 203 may receive data using an unlicensed CC (first frequency band). The transmitting/receiving section 203 may also transmit the DCI.

In addition, the transmitting/receiving section 203 may transmit information indicating the result of listening to the radio base station 10.

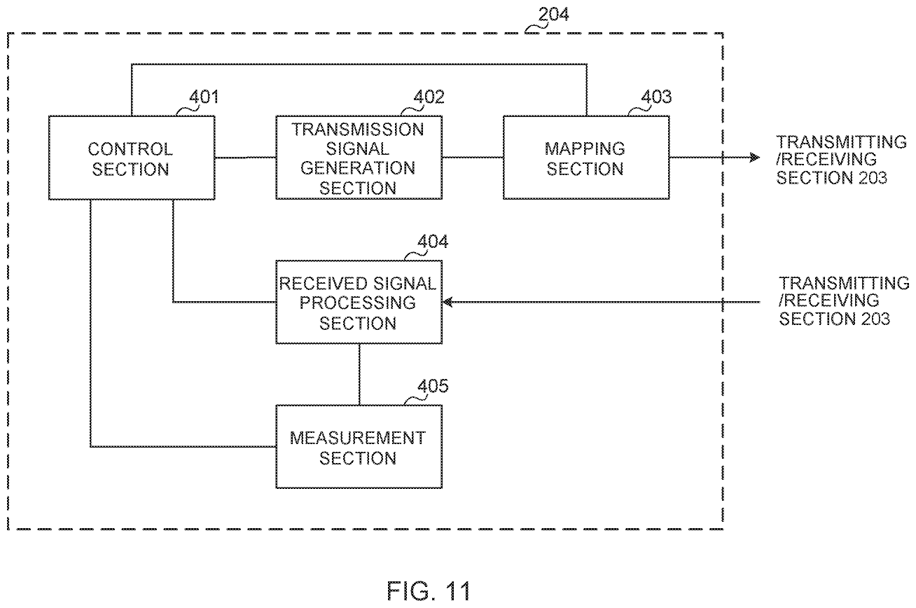

FIG. 11 is a diagram illustrating an example of a functional configuration of the user terminal according to the present embodiment. Note that it is assumed that FIG. 11 mainly illustrates functional blocks that are feature portions of the present embodiment and the user terminal 20 includes other functional blocks necessary for radio communication. As illustrated in FIG. 11, the baseband signal processing section 204 of the user terminal 20 at least includes a control section 401, a transmission signal generating section 402, a mapping section 403, a reception signal processing section 404, and a measuring section 405.

The control section 401 performs control of the entire user terminal 20. The control section. 401 may be constituted by a controller, a control circuit, or a control apparatus described based on a common recognition in Technical Field of the present invention.

The control section 401 controls, for example, generation of a signal performed by the transmission signal generating section 402 and allocation of the signal performed by the mapping section 403. The control section 401 also controls signal -reception processing performed by the reception signal processing section 404 and signal measurement performed by the measuring section 405.

Further, the control section 401 may control listening in an unlicensed CC.

In addition, the control section 401 may control transmission of data on the basis of a given condition even if the busy state is detected in listening performed prior to transmission of the data scheduled in accordance with the DCI. The given condition may be whether or not the transmission source and the destination of the signal detected in the listening are recognizable.

The transmission signal generating section 402 generates an uplink signal (such as an uplink control channel, an uplink data channel, or an uplink reference signal) on the basis of an instruction from the control section 401, and outputs the uplink signal to the mapping section 403. The transmission signal generating section 402 may be constituted by a signal generator, a signal generation circuit, or a signal generation apparatus described based on a common recognition in Technical Field of the present invention.

The transmission signal generating section 402 generates an uplink data channel on the basis of an instruction from the control section 401. For example, when the downlink control channel which is reported from the radio base station. 10 includes the UL grant, the transmission signal generating section 402 is instructed by the control section 401 to generate an uplink data channel.

The mapping section 403 maps the uplink signal generated by the transmission signal generating section 402 to a radio resource on the basis of an instruction from the control section 401 and outputs the resultant uplink signal to the transmitting/receiving section 203. The mapping section 403 may be constituted by a mapper, a mapping circuit, or a mapping apparatus described based on a common recognition in Technical Field of the present invention.

The reception signal processing section 404 performs reception processing (for example, demapping, demodulation, decoding, and so on) on a reception signal input thereto from the transmitting/receiving section 203. Here, the reception signal is, for example, a downlink signal (such as a downlink control channel, a downlink data channel, or a downlink reference signal) transmitted from the radio base station 10. The reception signal processing section 404 may be constituted by a signal processor, a signal processing circuit, or a signal processing apparatus described based on a common recognition in Technical Field of the present invention. In addition, the reception signal processing section 404 may constitute a reception section according to the present invention.

On the basis of an instruction from the control section 401, the reception signal processing section 404 performs blind decoding on a downlink control channel for which at least one of transmission and reception of a downlink data channel is scheduled, and performs reception processing on the downlink data channel on the basis of the DCI. The reception signal processing section 404 also estimates a channel gain on the basis of the DM-RS or the CRS, and demodulates the downlink data channel on the basis of the estimated channel gain.

The reception signal processing section 404 outputs information decoded through the reception processing to the control section 401. The reception signal processing section 404 outputs, for example, broadcast information, system information, RRC signaling, DCI, and so on to the control section 401. The reception signal processing section. 404 may output the data decoding result to the control section 401. The reception signal processing section 404 also outputs the reception signal, and a signal resulting from the reception processing to the measuring section 405.

The measuring section 405 performs measurement on the received signal. The measuring section 405 may be constituted by a measurer, a measuring circuit, or a measuring apparatus described based on a common recognition in Technical Field of the present invention.

The measuring section 405 may measure the received power (for example, RSRP), the DL received quality (for example, RSRQ), the channel state, or the like of the received signal. A result of the measurement may be output to the control section 401.

### <Hardware Configuration>

Block diagrams used in the description of the embodiment above illustrate blocks in functional units, These functional blocks (constituent units) are implemented by any combination of hardware and/or software. In addition, the method for implementing each functional block is not particularly limited. That is, each functional block may be implemented by using a single physically and/or logically integrated apparatus, or two or more physically and/or logically separate apparatuses may be connected directly and/or indirectly (for example, using a cable and/or radio) and each functional block may be implemented by using the plurality of apparatuses.

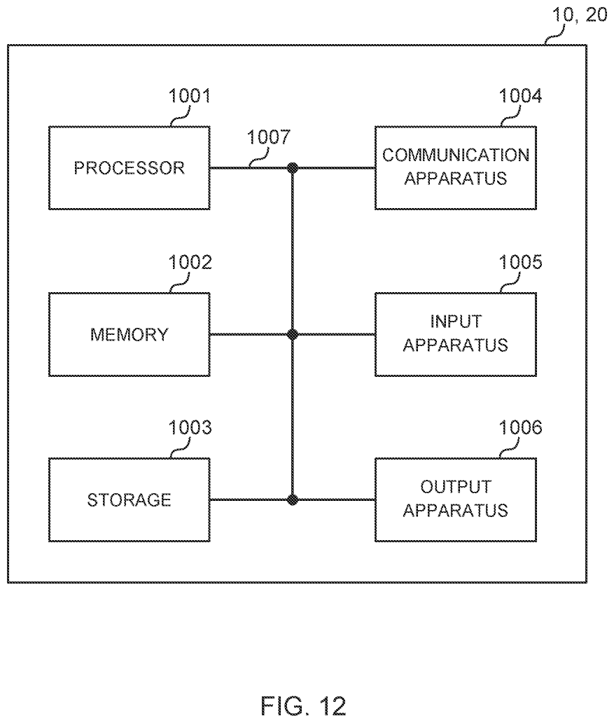

For example, the radio base station, the user terminal, and so on according to one embodiment of the present invention may function as computers that perform a process based on a radio communication method of the present invention. FIG. 12 is a diagram illustrating an example of a hardware configuration or the radio base station and the user terminal according to one embodiment of the present invention. The radio base station 10 and the user terminal 20 described above may be each physically configured as a computer apparatus including a processor 1001, a memory 1002, storage 1003, a communication apparatus 1004, an input apparatus 1005, a output apparatus 1006, and a bus 1007.

Note that the term “apparatus” can be interpreted as a circuit, device, unit, or the like in the following description. The hardware configuration of the radio base station 10 and the user terminal 20 may be configured to include one or a plurality of apparatuses each illustrated in the figure or may be configured to omit part of the apparatus.

For example, only a single processor 1001 is illustrated but a plurality of processors may be included. In addition, processes may be executed by a single processor, or processes may be executed by one or more processors concurrently, sequentially, or using another technique. Note that the processor 1001 may be implemented by one or more chips.

Each function of the radio base station 10 and the user terminal 20 is implemented, for example, by loading given software (program) to hardware such as the processor 1001 and the memory 1002, thereby causing the processor 1001 to perform operations, control communication performed via the communication apparatus 1004, and control reading and/or writing of data from and to the memory 1002 and the storage 1003.

The processor 1001 causes the operating system to operate, thereby controlling the entire computer, for example. The processor 1001 may be constituted by a CPU (Central Processing Unit) including an interface to a peripheral apparatus, a control apparatus, an arithmetic apparatus, and a register. For example, the above-described sections such as the baseband signal processing section 104 (204) and the call processing section 105 may be implemented by the processor 1001.

The processor 1001 also reads a program (program code), a software module, data, and so on from the storage 1003 and/or the communication apparatus 1004 to the memory 1002 to perform various processes in accordance with these. As the program, a program causing a computer to perform at least part of the operation described in the embodiment above is used. For example, the control section 401 of the user terminal 20 may be implemented by a control program that is stored in the memory 1002 and that operates on the processor 1001. The other functional blocks may be implemented in the similar manner.

The memory 1002 is a computer-readable recording medium, and may be constituted by at least one of a ROM (Read Only Memory), an EPROM (Erasable Programmable ROM), an EEPROM (Electrically EPROM), a RAM (Random Access Memory), or another appropriate storage medium, for example. The memory 1002 may be referred to as a register, a cache, a main memory (main memory device), or the like. The memory 1002 can store a program (program code), a software module, and so on that are executable to carry out the radio communication method according to one embodiment of the present invention.

The storage 1003 is a computer-readable recording medium, and may be constituted by at least one of a flexible disk, a floppy (registered trademark) disk, a magneto-optical disc (for example, a compact disc (such as a CD-ROM (Compact Disc ROMS)), a digital versatile disc, a Blu-ray (registered trademark) disc), a removable disk, a hard disk drive, a smart card, a flash memory device (for example, a card, a stick, or a key drive), a magnetic stripe, a database, a server, or another appropriate storage medium, for example. The storage 1003 may be referred to as an auxiliary storage apparatus.

The communication apparatus 1004 is hardware (transmission/reception device) for performing communication between computers via a wired and/or wireless network, and may be referred to as a network device, a network controller, a network card, or a communication module, for example. The communication apparatus 1004 may be configured to include a high-frequency switch, a duplexer, a filter, a frequency synthesizer, and so on to implement FDD (Frequency Division Duplex) and/or TDD (Time Division. Duplex), for example. For example, the above-described sections such as the transmit/receive antennas 101 (201), the amplifying sections 102 (202), the transmitting/receiving sections 103 (203), and the communication path interface 106 may be implemented by the communication apparatus 1004.

The input apparatus 1005 is an input device (for example, a keyboard, a mouse, a microphone, a switch, a button, a sensor, and so on) that accepts an input from outside. The output apparatus 1006 is an output device (for example, a display, a speaker, an LED (Light Emitting Diode) lamp, and so on) that implements an output to outside. Note that the input apparatus 1005 and the output apparatus 1006 may be an integrated component (for example, a touch panel).

In addition, apparatuses such as the processor 1001 and the memory 1002 are connected to one another by the bus 1007 for communicating information. The bus 1007 may be constituted by a single bus or may be constituted by different buses between. different apparatuses.

Further, the radio base station 10 and the user terminal 20 may be configured to include pieces of hardware such as a microprocessor, a DSP (Digital Signal Processor), an. ASIC (Application Specific Integrated Circuit), a PLD (Programmable Logic Device), or an FPGA (Field Programmable Gate Array), and one or some of or all of the functional blocks may be implemented using the pieces of hardware. For example, the processor 1001 may be implemented using at least one of these pieces of hardware.

### (Modifications)

Note that the terms described herein and/or the terms that are necessary to understand this description may be replaced with other terms having the same or similar meanings. For example, channels and/or symbols may be signals (signaling). In addition, signals may be messages. A reference signal may be abbreviated as an RS (Reference Signal) and may be referred to as a pilot or a pilot signal depending on the specifications to be applied. Further, a CC (Component Carrier) may be referred to as a cell, a frequency carrier, a carrier frequency, and so on.

In addition, a radio frame may be constituted by one or a plurality of periods (frames) in the time domain. Each of the one or plurality of periods (frames) constituting a radio frame may be referred to as a subframe. Further, a subframe may be constituted by one or a plurality of slots in the time domain. A subframe may have a fixed time duration (for example, 1 ms) that does not depend on the numerology.

Further, a slot may be constituted by one or a plurality of symbols (such as OFDM (Orthogonal Frequency Division Multiplexing) symbols, SC-FDMA (Single Carrier Frequency Division Multiple Access) symbols) in the time domain. In addition, a slot may be a time unit based on the numerology. Further, a slot may include a plurality of mini-slots. Each muni-slot may be constituted by one or a plurality of symbols in the time domain. In addition, a mini-slot may be referred to as a subs lot.

A radio frame, a subframe, a slot, a mini-slot, and a symbol each represent the time unit in signal transmission. Another corresponding name may be used for each of a radio frame, a subframe, a slot, a mini-slot, and a symbol. For example, one subframe may be referred to as a TTI (Transmission Time Interval). A plurality of contiguous subframes may be referred to as a TTI. One slot or one mini-slot may be referred to as a TTI. That is, a subframe and/or a TTI may be a subframe (1 ms) in the existing LTE, may be a period (of 1 to 13 symbols, for example) shorter than 1 ms, or a period longer than 1 ms. Note that a unit representing a TTI may be referred to as a slot, a mini-slot, or the like as well as a subframe.

In this regard, a TTI refers to the minimum time unit of scheduling in radio communication, for example. For example, in LTE systems, a radio base station performs scheduling to allocate radio resources (such as the frequency bandwidth and the transmission power that can be used by each user terminal) to each user terminal in the TTI units. Note that the definition of the TTI is not limited to this.

A TTI may be a transmission time unit of a channel-encoded data packet (transport block), code block, and/or code word or may be a processing unit of scheduling, link adaptation, or the like. Note that when a TTI is given, a time interval (for example, the number of symbols) to which the transport block, code block, and/or code word are actually mapped may be shorter than the TTI.

Note that when one slot or one mini-slot is referred to as a TTI, one or more TTIs (that is, one or more slots or one or more mini-slots) may be the minimum time unit of scheduling. In addition, the number of slots (the number of mini-slots) constituting the minimum time unit of scheduling may be controlled.

A TTI having a time duration of 1 ms may be referred to as a general TTI (TTI in LTE Rel. 8 to 12), a normal TTI, a long TTI, a general subframe, a normal subframe, a long subframe, or the like. A TTI that is shorter than a general TTI may be referred to as a shortened TTI, a short TTI, a partial or fractional TTI, a shortened subframe, a short subframe, a mini-slot, a subslot, or the like.

Note that a long TTI (such as a general TTI or a subframe, for example) may be interpreted as a TTI having a time duration exceeding 1 ms. A short TTI (such as a shortened TTI, for example) may be interpreted as a TTI having a TTI duration that is less than the TTI duration of the long ITT and is greater than or equal to 1 ms.

An RB (Resource Block) is the unit of resource allocation in the time domain and the frequency domain, and may include one or a plurality of contiguous subcarriers in the frequency domain. In addition, an RB may include one or a plurality of symbols in the time domain, and may have a duration of one slot, one mini-slot, one sub frame or one TTI. One TTI and one subframe each may be constituted by one or a plurality of resource blocks. Note that one or a plurality of REs may be referred to as a PRB (Physical RB), an SCG (Sub-Carrier Group), an REG (Resource Element Group), a PRB pair, an RB pair, or the like.

In addition, a resource block may be constituted by one or a plurality of REs (Resource Elements). For example RE may be a radio resource domain of one sub carrier and one symbol.

Note that the above-described structures of a radio frame, a subframe, a slot, a mini-slot, a symbol, and so on are merely examples. For example, configurations such as the number of subframes included in a radio frame, the number of slots included in a subframe or radio frame, the number of mini-slots included in a slot, the numbers or symbols and RBs included in a slot or mini-slot, the number of subcarriers included in a RB, the number of symbols in a TTI, the symbol duration, and the CP (Cyclic Prefix) length can be variously modified.

In addition, the information, parameters, and the like described herein may be represented in absolute values or in relative values with respect to given values, or may be represented using other corresponding information. For example, radio resources may be specified by given indices.

The names used for the parameters and the like herein are by no means restrictive ones. For example, various channels (such as a PUCCH (Physical Unlink Control Channel) and a PDCCH (Physical Downlink Control Channel)) and information elements are identifiable by various preferable names, and various names assigned to these various channels and information elements are by no means restrictive ones.

The information, signals, and the like described herein may be represented by using any of various different. technologies. For example, data, instructions, commands, information, signals, bits, symbols, chips, and so on which can be mentioned throughout the description above, may be represented by voltages, currents, electromagnetic waves, magnetic fields or particles, optical fields or photons, or any combination of these.

In addition, information, signals, and the like can be output from a higher layer to a lower layer and/or from a lower layer to a higher layer. Information, signals, and the like may be input and output via a plurality of network nodes.

The input or output information, signals, and the like may be stored in a particular location (for example, a memory) or may be managed using a management table. The input or output information, signals, and the like may be overwritten, updated, or appended. The output information, signals, and the like may be deleted. The input information, signals, and the like may be transmitted to another apparatus.

Reporting of information is not limited to the aspect/embodiment described herein and may be performed using another method. For example, reporting of information. may be performed through physical layer signaling (for example, DCI (Downlink Control Information), UCI (Uplink Control Information)), higher-layer signaling (for example, RRC (Radio Resource Control) signaling, broadcast information (such as an MIB (Master Information Block) or an SIB (System Information Block)), MAC (Medium Access Control) signaling), or another signal, or any combination of these.

Note that the physical layer signaling may be referred to as L1/L2 (Layer 1/Layer 2) control information (L1/L2 control signal), L1 control information. (L1 control signal), or the like. In addition, RRC signaling may be referred to as an RFC message, and may be, for example, an RRC connection setup message, an RRC connection reconfiguration. message, or the like. In addition, MAC signaling may be reported using, for example, a MAC CE (Control Element).

In addition, reporting of given information (for example, reporting indicating that “X holds”) is not limited to explicit reporting and may be made implicitly (for example, by not reporting the given information or by reporting other information).

Determination may be made by a value (0 or 1) represented by one bit or by. Boolean represented by true or false, or may be made by comparison of numerical values (for example, comparison with a given value).

Software should be interpreted broadly to mean commands, command sets, code, code segments, program codes, programs, sub-programs, software modules, applications, software applications, software packages, routines, subroutines, objects, executable files, running threads, procedures, functions, or the like, irrespective of whether or not the software is called software, firmware, middleware, microcode, hardware descriptive language, or is called by another name.

In addition, software, commands, information and so on. may be transmitted and received via communication media. For example, when software is transmitted from a website, a server, or other remote sources by using wired technologies (such as coaxial cables, optical fiber cables, twisted-pair cables, and DSL (Digital Subscriber Lines)) and/or wireless technologies (infrared radiation and microwaves), these wired technologies and/or wireless technologies are also included in the definition of the communication media.

The terms “system” and “network” used herein can be used interchangeably.

Herein, the terms “base station (BS)”, “radio base station”, “eNB”, “gNB”, “cell”, “sector”, “cell group”, “carrier”, and “component carrier” can be used interchangeably. A base station may be referred to as the terms fixed station, NodeB, eNodeB (eNB), access point, transmission point, reception point, transmission reception point, femtocell, smallcell, or the like.

A base station can accommodate one or a plurality of (for example, three) cells (also referred to as sectors). When a base station accommodates a plurality of cells, the entire coverage area of the base station can be partitioned into a plurality of smaller areas, and each of the smaller areas can provide communication services using a base station sub-system (for example, an indoor small base station (RRH: Remote Radio Head)). The term “cell” or “sector” refers to a part or entirety of the coverage area of a base station and/or a base station sub-system that provides communication services in this coverage.

Herein, the terms “MS (Mobile Station)”, “user terminal”, “UE (User Equipment)”, and “terminal” can be used. interchangeably.

A mobile station may also be referred to as a subscriber station, a mobile unit, a subscriber unit, a wireless unit, a remote unit, a mobile device, a wireless device, a wireless communication device, a remote device, a mobile subscriber station, an access terminal, a mobile terminal, a wireless terminal, a remote terminal, a handset, a user agent, a mobile client, a client, or some other appropriate terms.

A base station and/or a mobile station may also be referred to as a transmission apparatus or a reception apparatus.

In addition, radio base stations may be interpreted as user terminals herein. For example, each aspect/embodiment of the present invention may be applied to a configuration in which communication between a radio base station and a user terminal is replaced with communication among a plurality of user terminals (D2D: Device-to-Device). In this case, the user terminals 20 may be configured to have the functions of the radio base stations 10 described above. In addition, wording such as “uplink” and “downlink” may be interpreted as “side”. For example, an uplink channel may be interpreted as a side channel.

Likewise, user terminals may be interpreted as radio base stations herein In this case, the radio base stations 10 may be configured to have the functions of the user terminals 20 described above.

Herein, operations described to be performed by a base station may be performed by a higher node (upper node) of the base station in some cases. It is obvious that, in a network including one or a plurality of network nodes having base stations, various operations performed for communication with terminals can be performed by base stations, one or more network nodes other than the base stations (for example, but not limited to, an MME (Mobility Management Entity), an S-GW (Serving-Gateway), or the like are conceivable) or combinations of these.

The aspects/embodiments described herein may be used individually or in combinations, which may be switched with execution. The order of processing procedures, sequences, flowcharts, and so on according to the aspects/embodiments described herein may be re-ordered as long as inconsistencies do not arise. For example, various step elements are presented in an illustrative order for the methods described herein and are not limited to the presented specific order.

The aspects/embodiments described herein may be applied. to systems that use LTE (Long Term Evolution), LTE-A (LTE-Advanced), LTE-B (LTE-Beyond), SUPER 3G, IMI-Advanced, 4G (4th generation mobile communication system), 5G (5th generation mobile communication system), ERA (Future Radio Access), New-RAT (Radio Access Technology), NR (New Radio), NE (New radio access), FX (Future generation radio access), GSM (registered trademark) (Global System for Mobile Communications), CDMA 2000, UMB (Ultra Mobile Broadband), IEEE 802.11 (Wi-Fi (registered trademark)), IEEE 802.16 (WiMAX (registered trademark)), IEEE 802.20, UWB (Ultra-WideBand), Bluetooth (registered trademark), and other appropriate radio communication methods and/or next-generation systems that are enhanced based on these.

The expression. “on the basis of (based on)” used herein does not mean “on the basis only of (based only on)” unless otherwise specified. That is, the expression. “on the basis of (based on)” means both “on the basis only of (based only on)” and “on the basis at least of (based at least on)”.

Various references to elements for which the terms “first”, “second”, and so on are used, which are used herein, do not generally limit the quantities or orders of those elements. These terms can be used herein as a convenient method for distinguishing between two or more elements. Thus, references to a first element and a second element does not mean that only two elements can be adopted or that first element needs to precede the second element in some way.

The term “determining” used herein may encompass various operations. For example, “determining” may be regarded as “determining” as to calculating, computing, processing, deriving, investigating, looking up (for example, looking up in a table, database, or another data structure), ascertaining, or the like. In addition, “determining” may be regarded as “determining.” as to receiving (for example, receiving information), transmitting (for example, transmitting information), inputting, outputting, accessing. (for example, accessing data in a memory), or the like. Further, “determining” may be regarded as “determining” as to resolving, selecting, choosing, establishing, comparing, or the like. That is, “determining” may be regarded as determining some kind of operation.

The terms “connected”and “coupled”used herein and various modifications of these mean various direct or indirect connections or couplings between two or more elements, and can include the case where one or more intermediate elements are present between two elements “connected” or “coupled” to each other. Connection or coupling between elements may physical, logical, or a combination of these. For example, “connection” may be interpreted as “access”.

Herein, when two elements are connected, it is considered that the two elements are “connected” or “coupled.” to each other using one or more electric wires, cables, and/or printed electric connections, and, in some non-restrictive non-comprehensive examples, using electromagnetic energy having a wavelength of a radio frequency region, a microwave region, and/or a light (both visible and invisible) region.

Herein, the expression “A and B being different” may mean that “A and B are different from each other”. The terms “separated”, “coupled”, and so on may be interpreted in the similar manner.

When “including”, “comprising”, and modifications of these are used in the description or the claims, these terms intend to be comprehensive lust lite the term “having”. Further, the term “or” used in the description and the claims intends not to be exclusive or.

While the present invention has been described in detail above, it is obvious to a person skilled in the art that the present invention is not limited to the embodiments described herein. The present invention can be implemented as corrected or modified aspects without departing from the spirit and scope of the present invention defined by the recitations of the claims. Consequently, the description herein is provided only for the illustrative purposes and provides no limiting meanings to the present invention in any way.

1. A radio base station comprising:
a transmission section that transmits downlink control information; and
a control section that controls scheduling of data, based on a relationship between an interfered apparatus and a destination apparatus, the interfered apparatus being an apparatus that is interfered with by transmission of the data scheduled in accordance with the downlink control information, the destination apparatus being a destination of data from an interfering apparatus that interferes with a transmission apparatus of the scheduled data.

2. The radio base station according to claim 1, further comprising:
a reception section that receives information indicating a result of listening from at least one of a user terminal and an adjacent radio base station, wherein
the control section determines the relationship between the interfered apparatus and the destination apparatus using a table that is generated based on the information and that associates the transmission apparatus with the interfered apparatus.

3. The radio base station according to claim 1, wherein in a case where the interfered apparatus does not include the destination apparatus, the control section schedules the data from the transmission apparatus to a resource that is identical to a resource of the data from the interfering apparatus to the destination apparatus in terms of at least one of a time domain and a frequency domain.

4. The radio base station according to claim 1, wherein
the transmission apparatus is the radio base station, and
the transmission section transmits the data scheduled in accordance with the downlink control information even in a case where a busy state is detected in listening prior to transmission of the data.

5. A user terminal comprising:
a reception section that receives downlink control information; and
a control section that controls, based on a given condition, transmission of data scheduled in accordance with the downlink control information even in a case where a busy state is detected in listening prior to transmission of the data.

6. The user terminal according to claim 5, wherein the given condition is whether or not a transmission source and a destination of a signal detected in the listening are recognizable.

7. The radio base station according to claim 2, wherein in a case where the interfered apparatus does not include the destination apparatus, the control section schedules the data from the transmission apparatus to a resource that is identical to a resource of the data from the interfering apparatus to the destination apparatus in terms of at least one of a time domain and a frequency domain.

8. The radio base station according to claim 2, wherein
the transmission apparatus is the radio base station, and
the transmission section transmits the data scheduled in accordance with the downlink control information even in a case where a busy state is detected in listening prior to transmission of the data.

9. The radio base station according to claim 3, wherein
the transmission apparatus is the radio base station, and
the transmission section transmits the data scheduled in accordance with the downlink control information even in a case where a busy state is detected in listening prior to transmission of the data.
